(19) United States
(12) Patent Application Publication
(10) Pub. No.: US 2022/0397106 A1
(43) Pub. Date: Dec. 15, 2022

(54) Fluid Pumping Device

(71) Applicant: Kevin Imai, Toledo, WA (US)

(72) Inventor: Kevin Imai, Toledo, WA (US)

(21) Appl. No.: 17/344,936

(22) Filed: Jun. 10, 2021

(51) Int. Cl. F04B 9/14; F04B 15/02; F04B 23/02

(52) U.S. Cl. CPC F04B 9/14; F04B 15/02; F04B 23/025

(57) ABSTRACT

A fluid pumping device for portioned dispensation of viscous fluids includes a base, which is configured to be positioned on a substantially horizontal surface. A pipe is engaged to and extends from a top of the base. A pump is operationally engaged to the pipe distal from the base. A spout is engaged to and extends from the base. The spout and the pump are in fluidic communication with the pipe. A socket is engaged to the pump so that the pump is in fluidic communication with a reservoir defined by the socket. The socket is complementary to a neck of a container containing a viscous fluid and thus can threadedly engage the container so that the container is inverted relative to the substantially horizontal surface. The reservoir holds the viscous fluid flowing from the container. The viscous fluid is pumped through the pipe and the spout by the pump.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pumping devices and more particularly pertains to a new pumping device for portioned dispensation of viscous fluids. The present invention discloses a pumping device comprising a pump and spout positioned on a base. A socket around the pump is engageable to a neck of an inverted container, positioning the pump to motivate a viscous fluid in the inverted container through the spout.

### (2) Description of Related Art Including Information Disclosed Under 37 CFR 1.97 and 1.98

The prior art relates to pumping devices. The prior art devices for dispensing viscous fluids from inverted containers comprise pumps, plungers, roller balls positioned in an orifice. What is lacking in the prior art is a pumping device comprising a pump and spout positioned on a base. A socket around the pump is engageable to a neck of one of a variety of inverted containers, positioning the pump to motivate a viscous fluid in the inverted container through the spout.

### BRIEF SUMMARY OF THE INVENTION

An embodiment of the disclosure meets the needs presented above by generally comprising a base, which is configured to be positioned on a substantially horizontal surface. A pipe is engaged to and extends from a top of the base. A pump is operationally engaged to the pipe distal from the base. A spout is engaged to and extends from the base. The spout and the pump are in fluidic communication with the pipe. A socket is engaged to the pump so that the pump is in fluidic communication with a reservoir, which is defined by the socket. The socket is threaded complementarily to a neck of a container containing a viscous fluid. The socket is configured to threadedly engage the container so that the container is inverted relative to the substantially horizontal surface. The reservoir is configured to hold the viscous fluid flowing from the container. The pump is configured to pump the viscous fluid through the pipe and the spout.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fluid pumping device according to an embodiment of the disclosure.

FIG. 2 is an in-use view of an embodiment of the disclosure.

FIG. 3 is a rear view of an embodiment of the disclosure.

FIG. 4 is a side view of an embodiment of the disclosure.

FIG. 5 is a bottom view of an embodiment of the disclosure.

FIG. 6 is a front view of an embodiment of the disclosure.

### DETAILED DESCRIPTION OF THE INVENTION

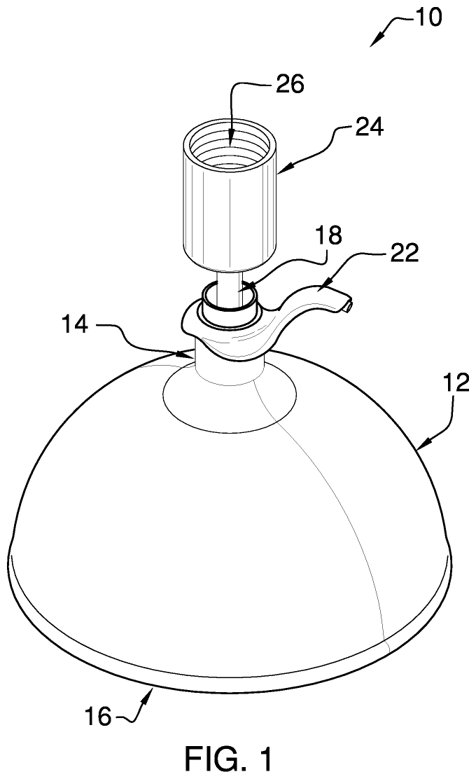

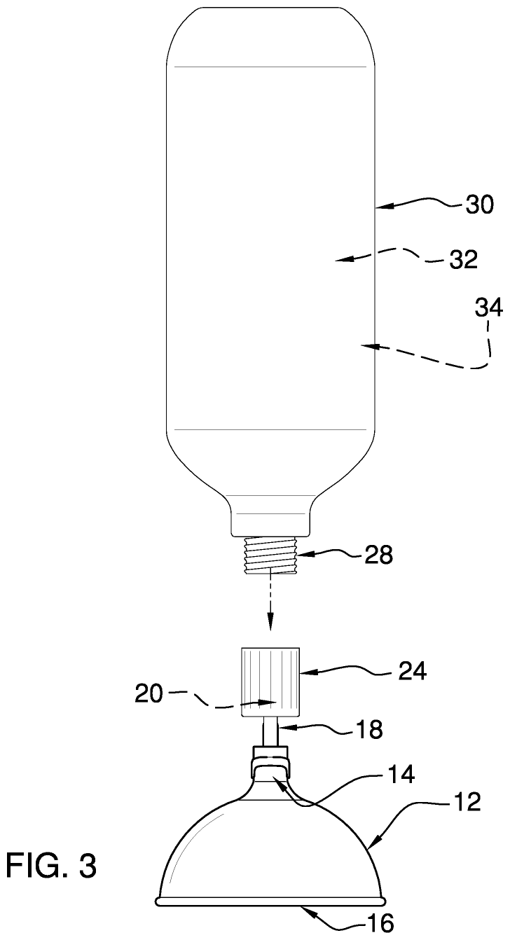

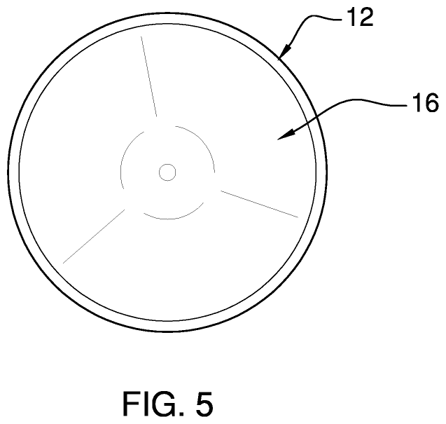

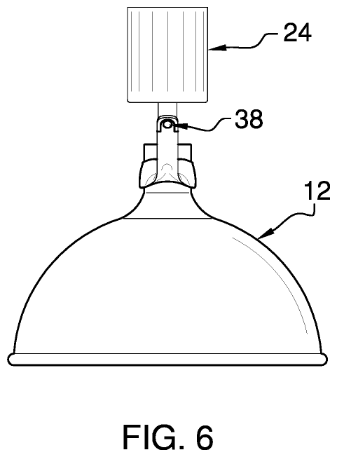

With reference now to the drawings, and in particular to FIGS. 1 through 6 thereof, a new pumping device embodying the principles and concepts of an embodiment of the disclosure and generally designated by the reference numeral 10 will be described.

As best illustrated in FIGS. 1 through 6, the fluid pumping device 10 generally comprises a base 12, which is configured to be positioned on a substantially horizontal surface. The base 12 has a top 14 and a bottom 16, with the top 14 being circumferentially smaller than the bottom 16 so that the base 12 tapers from the bottom 16 to the top 14. The top 14 and the bottom 16 may be substantially circularly shaped so that the base 12 is substantially hemispherically shaped. The present invention also anticipates the base 12 being alternatively shaped, such as cuboid shaped, frustum shaped, and the like.

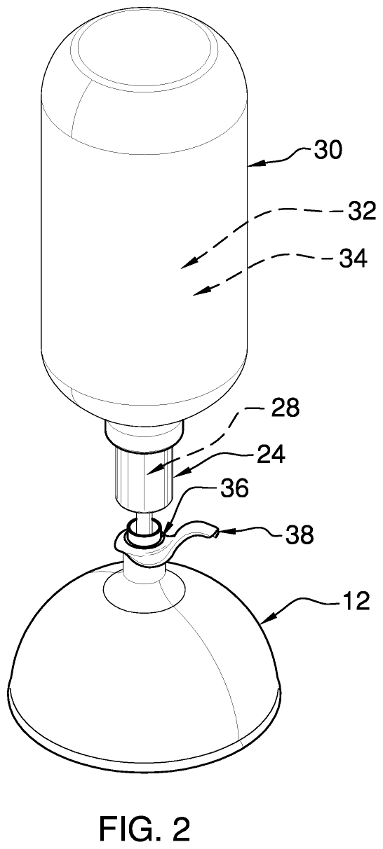

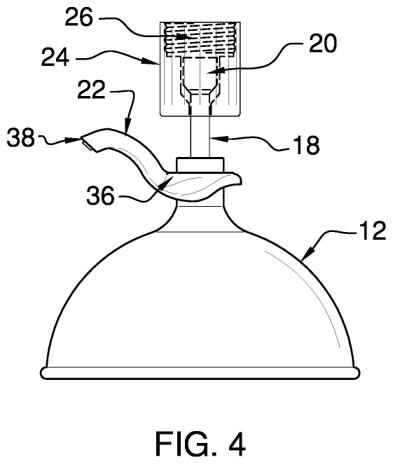

A pipe 18 is engaged to and extends from the top 14 of the base 12. A pump 20 is operationally engaged to the pipe 18 distal from the base 12, as shown in FIG. 4. A spout 22 is engaged to and extends from the base 12. The spout 22 and the pump 20 are in fluidic communication with the pipe 18. A socket 24 is engaged to the pump 20 so that the pump 20 is in fluidic communication with a reservoir 26, which is defined by the socket 24. The socket 24 is threaded complementarily to a neck 28 of a container 30 containing a viscous fluid 32, such as a lotion 34. The socket 24 is configured to threadedly engage the container 30 so that the container 30 is inverted relative to the substantially horizontal surface, as shown in FIG. 2. The reservoir 26 is configured to hold the viscous fluid 32 flowing from the container 30. The pump 20 is configured to pump the viscous fluid 32 through the pipe 18 and the spout 22.

The spout 22 is arcuate, as shown in FIG. 4. When the base 12 is positioned on the substantially horizontal surface, a first end 36 of the spout 22, which is engaged to the base 12, is lower than a second end 38 the spout 22, which is distal from the base 12. The spout 22 being arcuate and the second end 38 being higher than the first end 36 help to prevent drippage of the viscous fluid 32 from the spout 22.

The pump 20 may be spring-loaded, as would be apparent to those skilled in the art of pump dispensers. The pump 20 thus would be configured to be actuated by pushing down upon the container 30 engaged to the socket 24. After the container 30 is pushed downwardly, a spring (not shown) of the pump 20 returns the container 30 to a default position wherein the container 30 is extended from the base 12. An intended use of the fluid pumping device 10 is to enable a user to dispense the final portions of the viscous fluid 32 from a container 30 substantially emptied of viscous fluid 32. The fluid pumping device 10 also could be utilized with a container 30 substantially filled with viscous fluid 32 when the pump 20 is equipped with a spring capable of returning the container 30 to the default position.

In use, the fluid pumping device 10 in engaged to the container 30 by threadedly inserting the neck 28 of the container 30 into the socket 24. With the base 12 positioned on the substantially horizontal surface, the viscous fluid 32 flows from the container 30 into the reservoir 26. Pushing down on the container 30 actuates the pump 20, causing the viscous fluid 32 to be pumped through the pipe 18 and the spout 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid pumping device comprising:
a base configured for positioning on a substantially horizontal surface;
a pipe engaged to and extending from a top of the base;
a pump operationally engaged to the pipe distal from the base;
a spout engaged to and extending from the base, the spout and the pump being in fluidic communication with the pipe; and
a socket engaged to the pump, such that the pump is in fluidic communication with a reservoir defined by the socket, the socket being threaded complementarily to a neck of a container containing a viscous fluid, wherein the socket is configured for threadedly engaging the container such that the container is inverted relative to the substantially horizontal surface, wherein the reservoir is configured for holding the viscous fluid flowing from the container, wherein the pump is configured for pumping the viscous fluid through the pipe and the spout.

2. The fluid pumping device of claim 1, wherein the top is circumferentially smaller than a bottom of the base, such that the base tapers from the bottom to the top.

3. The fluid pumping device of claim 2, wherein the top and the bottom are substantially circularly shaped, such that the base is substantially hemispherically shaped.

4. The fluid pumping device of claim 1, wherein the spout is arcuate, such that a first end of the spout engaged to the base is lower than a second end of the spout distal from the base when the base is positioned on the substantially horizontal surface.

5. The fluid pumping device of claim 1, wherein the pump is spring-loaded, wherein the pump is configured for actuating by pushing down upon the container engaged to the socket.

6. A fluid pumping system comprising:
a container;
a viscous fluid positioned in the container;
a base configured for positioning on a substantially horizontal surface;
a pipe engaged to and extending from a top of the base;
a pump operationally engaged to the pipe distal from the base;
a spout engaged to and extending from the base, the spout and the pump being in fluidic communication with the pipe; and
a socket engaged to the pump, such that the pump is in fluidic communication with a reservoir defined by the socket, the socket being threaded complementarily to a neck of the container, such that the socket is positioned for threadedly engaging the container such that the container is inverted relative to the substantially horizontal surface, such that the reservoir is positioned for holding the viscous fluid flowing from the container, such that the pump is positioned for pumping the viscous fluid through the pipe and the spout.

7. The fluid pumping system of claim 6, wherein the top is circumferentially smaller than a bottom of the base, such that the base tapers from the bottom to the top.

8. The fluid pumping system of claim 7, wherein the top and the bottom are substantially circularly shaped, such that the base is substantially hemispherically shaped.

9. The fluid pumping system of claim 6, wherein the spout is arcuate, such that a first end of the spout engaged to the base is lower than a second end of the spout distal from the base when the base is positioned on the substantially horizontal surface.

10. The fluid pumping system of claim 6, wherein the pump is spring-loaded, such that the pump is actuated by pushing down upon the container engaged to the socket.

11. A fluid pumping device comprising:
a base configured for positioning on a substantially horizontal surface, the base having a top and a bottom, the top being circumferentially smaller than the bottom, such that the base tapers from the bottom to the top, the top and the bottom being substantially circularly shaped, such that the base is substantially hemispherically shaped;
a pipe engaged to and extending from the top of the base;
a pump operationally engaged to the pipe distal from the base;
a spout engaged to and extending from the base, the spout and the pump being in fluidic communication with the pipe, the spout being arcuate, such that a first end of the spout engaged to the base is lower than a second end of the spout distal from the base when the base is positioned on the substantially horizontal surface; and
a socket engaged to the pump, such that the pump is in fluidic communication with a reservoir defined by the socket, the socket being threaded complementarily to a neck of a container containing a viscous fluid, wherein the socket is configured for threadedly engaging the container such that the container is inverted relative to the substantially horizontal surface, wherein the reservoir is configured for holding the viscous fluid flowing from the container, wherein the pump is configured for pumping the viscous fluid through the pipe and the spout, the pump being spring-loaded, wherein the pump is configured for actuating by pushing down upon the container engaged to the socket.
